(19) United States
(12) Patent Application Publication
(10) Pub. No.: US 2026/0082021 A1
(43) Pub. Date: Mar. 19, 2026

(54) SURVEILLANCE CAMERA

(71) Applicant: HANWHA VISION CO., LTD., Seongnam-si (KR)

(72) Inventors: Saerom Won, Seongnam-si (KR); Dongjin Park, Seongnam-si (KR); Jongin Park, Seongnam-si (KR); Gyu Tae Lee, Seongnam-si (KR)

(73) Assignee: HANWHA VISION CO., LTD., Seongnam-si (KR)

(21) Appl. No.: 19/326,135

(22) Filed: Sep. 11, 2025

(30) Foreign Application Priority Data
Sep. 13, 2024 (KR) 10-2024-0125738

(51) Int. Cl. H04N 7/18; H04N 23/661; H04N 23/695

(52) U.S. Cl. CPC H04N 7/185; H04N 23/661; H04N 23/695

(57) ABSTRACT

A surveillance camera includes: a communicator configured to receive, from a user terminal configured to measure position information and orientation information of the user terminal, the position information and the orientation information of the user terminal; a controller configured to set position information and orientation information of the surveillance camera based on the position information and orientation information of the user terminal; and a housing which accommodates the communicator and the controller therein, wherein the housing includes a user terminal contact configured to allow the user terminal to contact the user terminal contact at a predetermined angle with respect to the surveillance camera.

### CROSS-REFERENCE TO RELATED APPLICATION

This application claims the benefit of and priority to Korean Patent Application No. 10-2024-0125738, filed on September 13, 2024, the entire disclosure of which is incorporated herein in its entirety by reference.

### BACKGROUND

The present disclosure relates to a surveillance camera, and more particularly, to setting of position information and orientation information of the surveillance camera.

An Internet protocol (IP) camera, which is a kind of surveillance camera, is a surveillance camera system using an IP network, in which a plurality of surveillance IP cameras are installed. A position of each camera and an angle of view of each camera may be displayed on a digital map to provide various services such as object tracking and display of a surveillance area.

In order to provide such a service, it is necessary to set position information and orientation information of the surveillance camera. In related art, on-site, a camera installation operator checks position information of a place where the surveillance camera is installed, directly inputs the position information into the surveillance camera, physically adjusts a center of an angle of view of the surveillance camera, that is, an optical axis of the camera, to be directed in a forward-north direction, and then sets an initial direction to north.

However, in such a conventional method, an installation worker needs to prepare a separate terminal that can obtain current position information and orientation information to obtain the position information, and a surveillance camera needs to be directly rotated in a northward direction while checking the orientation information, which is labor-intensive for the installation worker and significantly inconvenient to setting.

The above description is only intended to facilitate the understanding of the background art of the technical ideas of the present disclosure, and therefore it cannot be understood as the content corresponding to the prior art known to those skilled in the art of the present disclosure.

### SUMMARY

In view of the above, an object of an embodiment of the present disclosure is to easily set position information and orientation information of a surveillance camera using a user terminal of a camera installation worker, such as a smartphone, etc.

Further, an object of an embodiment of the present disclosure is to accurately obtain, by using a surveillance camera that determines a relative angle with the user terminal of the camera installation worker, the orientation information of the surveillance camera, and easily calculate the orientation information of the surveillance camera based thereon.

The objects to be achieved by the present disclosure are not limited to the aforementioned objects, and other objects, which are not mentioned above, will be apparently appreciated by those skilled in the art from the following description.

In order to achieve the above-described object, the present disclosure provides a surveillance camera. The surveillance camera may include: a controller which sets position information and orientation information based on the received position information and orientation information of the user terminal; and a housing which accommodates the communicator and the controller therein, and the housing may include a user terminal contact which allows the user terminal to be disposed at a predetermined angle with respect to the surveillance camera.

The surveillance camera and other embodiments may include the following features.

According to the embodiment, the user terminal contact may be formed to be contacted with a of the user terminal so that an optical axis of the surveillance camera and the surface of the user terminal are perpendicular or parallel to each other.

According to the embodiment, the user terminal contact may have a shape and an area to be contacted with at least a portion of the surface of the user terminal.

According to the embodiment, the controller may obtain the orientation information of the surveillance camera, based on information about the surface of the user terminal, which is contacted with the user terminal contact, and the orientation information of the user terminal.

According to the embodiment, the housing may further include a magnetic field shielding film configured to block a magnetic field formed by an internal configuration of the housing with respect to the user terminal contact.

According to the embodiment, the communicator may be configured to receive the orientation information of the user terminal from the user terminal based on determining that the user terminal is in a state of being horizontal to a ground surface or within a predetermined inclination range with respect to the ground surface.

Further, in order to achieve the above-described object, the present disclosure provides another example of the surveillance camera. The surveillance camera may include: a camera module; and a housing which accommodates the camera module, and the housing may include a user terminal contact configured to allow a surface of a user terminal having orientation information to contact the user terminal contact at a predetermined angle with respect to an optical axis of the camera module.

The surveillance camera and other embodiments may further include the following features.

According to the embodiment, the user terminal contact may be configured to allow a surface of the user terminal to contact the user terminal contact so that an optical axis of the camera module and the surface of the user terminal are perpendicular or parallel to each other.

According to the embodiment, the user terminal contact may have a shape and an area to be contacted with at least a portion of the surface of the user terminal.

According to the embodiment, further, the surveillance camera may further include: a communicator configured to receive the orientation information of the user terminal from the user terminal; and a controller configured to set orientation information of the surveillance camera based on the orientation information of the user terminal based on the user terminal contacting the user terminal contact, and the communicator may be configured receive the orientation information of the user terminal based on the orientation information of the user terminal being transmitted according to determination of a gyro sensor based inclination of an installation app installed in the user terminal.

According to the embodiment, the controller may be configured to obtain the orientation information of the surveillance camera, based on information about the surface of the user terminal, which is contacted with the user terminal contact, and the orientation information of the user terminal.

According to the embodiment, a magnetic field shielding film that blocks a magnetic field formed by an internal configuration of the housing with respect to the user terminal contact may be formed on an inner surface of the housing.

Further, in order to achieve the above-described object, the present disclosure provides yet another example of the surveillance camera. The surveillance camera may include a housing which accommodates a camera module, a communicator, and a controller therein, wherein a user terminal contact configured to allow a user terminal to contact the user terminal contact at a predetermined angle is formed on an outer surface of the housing, the communicator may receive position information and orientation information of the user terminal from the user terminal, and the controller may set position information and orientation information of the surveillance camera based on the position information and the orientation information of the user terminal based on the user terminal contacting the user terminal contact.

The surveillance camera and other embodiments may further include the following features.

According to the embodiment, the communicator may receive the position information and the orientation information of the user terminal from the user terminal based on the user terminal being in a horizontal state with respect to a ground surface or in a state of being within a predetermined inclination value in a state in which the user terminal contacts the user terminal contact..

According to the embodiment, further, the user terminal contact may be formed to be contacted with a surface of the user terminal so that an optical axis of the camera module and a surface of the user terminal are perpendicular or parallel to each other.

According to the embodiment, the user terminal contact may have a shape and an area to be contacted with at least a portion of the surface of the user terminal.

According to the embodiment, further, the controller may be configured to obtain the orientation information of the surveillance camera, based on information about the surface of the user terminal, which is contacted with the user terminal contact, and the orientation information of the user terminal.

According to the embodiment, further, the housing may further include a magnetic field shielding film configured to block a magnetic field formed by an internal configuration of the housing with respect to the user terminal contact.

According to an embodiment disclosed in the present disclosure, there is an effect in which it is possible to easily set position information and orientation information of a surveillance camera using a user terminal of a camera installation worker, such as a smartphone, etc.

Further, according to an embodiment disclosed in the present disclosure, there is an effect in which it is possible to accurately obtain the orientation information of the surveillance camera, by using a surveillance camera that determines a relative angle with the user terminal of the camera installation worker, and easily calculate the orientation information of the surveillance camera based thereon.

Meanwhile, an object which can be achieved in the present disclosure is not limited to the aforementioned effects, and other not-mentioned effects will be obviously understood by those skilled in the art from the description below.

### BRIEF DESCRIPTION OF DRAWINGS

The following drawings attached to the present disclosure illustrate preferred embodiments of the present disclosure, and together with the detailed description, serve to further understand the technical idea of the present disclosure. Therefore, the present disclosure should not be construed as being limited only to the matters described in the drawings.

FIG. 1 is a diagram schematically illustrating a system in which a surveillance camera is used according to an embodiment of the present disclosure.

FIG. 2 is a block diagram schematically illustrating an internal configuration of the surveillance camera illustrated in FIG. 1.

FIG. 3 is a block diagram schematically illustrating an internal configuration of an image management server illustrated in FIG. 1.

FIG. 4 illustrates the surveillance camera according to an embodiment of the present disclosure.

FIG. 5 illustrates an example in which a user terminal contact is formed on a front surface of a housing and FIG. 7 illustrates an example in which the user terminal contact is formed on a side surfaces of the housing.

FIGS. 6 and 8 illustrate use examples of the surveillance camera according to an embodiment of the present disclosure.

FIG. 9 and 10 illustrate other examples of the user terminal contact formed in the housing.

FIGS. 11A and 11B illustrate examples of use locations of a user terminal contact portion and a user terminal viewed down from an upper portion of the surveillance camera in the use examples of the surveillance camera according to an embodiment of the present disclosure of FIGS. 6 and 8, respectively.

### DETAILED DESCRIPTION

The technology disclosed in this specification may be applied to surveillance cameras. However, the technology disclosed in this specification is not limited thereto and may be applied to all devices and methods to which the technical idea of the technology may be applied.

Technical terms used in this specification are used to merely illustrate specific embodiments, and should be understood that they are not intended to limit the present disclosure. As far as not being defined differently, all terms used herein including technical or scientific terms may have the same meaning as those generally understood by an ordinary person skilled in the art to which the present disclosure belongs, and should not be construed in an excessively comprehensive meaning or an excessively restricted meaning. In addition, if a technical term used in the description of the present disclosure is an erroneous term that fails to clearly express the idea of the present disclosure, it should be replaced by a technical term that may be properly understood by the skilled person in the art. In addition, general terms used in the description of the present disclosure should be construed according to definitions in dictionaries or according to its front or rear context, and should not be construed to have an excessively restrained meaning.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

As used herein, the term “and/or” includes any and all combinations of one or more of the associated listed items. As used herein, an expression “at least one of” preceding a list of elements modifies the entire list of the elements and does not modify the individual elements of the list. For example, an expression, “at least one of a, b, and c” and “at least one of a, b, or c” should be understood as including only a, only b, only c, both a and b, both a and c, both b and c, or all of a, b, and c.

In describing the present disclosure, if a detailed explanation for a related known function or construction is considered to unnecessarily divert the gist of the present disclosure, such explanation has been omitted but would be understood by those skilled in the art. The accompanying drawings are used to help easily understood the technical idea of the present disclosure and it should be understood that the idea of the present disclosure is not limited by the accompanying drawings.

Videos according to an embodiment of the present disclosure include both still images and moving images, unless there is a special limitation. The term “image” may refer to either a still image or a moving image herein.

Throughout the specification, a device or terminal includes a communication terminal or communication device capable of wired or wireless communication with a server or other device. The device or terminal may take various forms, such as a mobile phone, smartphone, smart pad, laptop computer, desktop computer, smart TV, or wearable device. Wearable devices may take various forms, such as a watch-type terminal, a glasses-type terminal, or a head-mounted display (HMD). Furthermore, the terminal is not limited to these forms and may be implemented as a variety of electronic devices. The apparatus may also be implemented as a server.

Hereinafter, embodiments of the present disclosure will be described in detail with reference to the accompanying drawings.

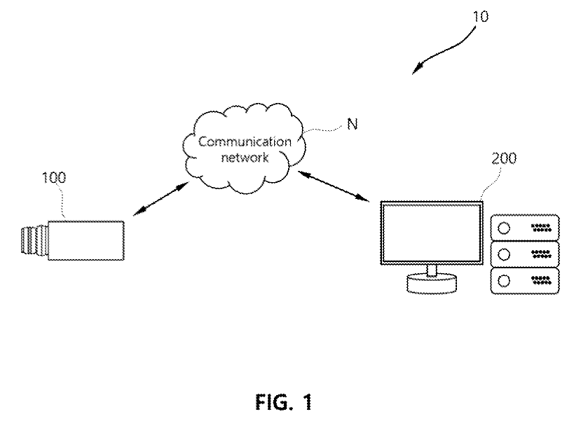

FIG. 1 is a diagram schematically illustrating a system in which a surveillance camera is used according to an embodiment of the present disclosure.

FIG. 1 illustrates a surveillance camera system 10 in which a surveillance camera 100 communicates with an image management server 200 via a network N.

Referring to FIG. 1, the surveillance camera system 10 for implementing a surveillance camera according to an embodiment of the present disclosure may include the surveillance camera 100 as an image capturing apparatus and the image management server 200 that receives and processes an image captured by the surveillance camera 100 and controls the surveillance camera 100.

The surveillance camera 100 may be an electronic device for photographing disposed at a fixed position of a specific place, may be an electronic device for photographing that maybe automatically or manually moved along a predetermined path, or may be an electronic device for photographing that may be moved by a person, a robot, or the like.

The surveillance camera 100 may be an IP camera or a network camera used by being connected to the Internet wiredly or wirelessly. The surveillance camera 100 may be a pan-tile-zoom (PTZ) camera having pan, tilt, and zoom functions. The surveillance camera 110 may have a function of recording a surveillance area or taking a picture. The surveillance camera 110 may have a function of recording a sound generated from the surveillance area. When a change such as a movement or a sound occurs in the surveillance area, the surveillance camera 110 may have a function of generating a notification or perform recording or photographing.

The image management server 200 may be a device that receives and stores an image itself captured through the surveillance camera 100 and/or an image obtained by editing the image. The image management server 200 may analyze the received image to correspond to a received purpose. For example, the image management server 200 may detect an object using an object detection algorithm in order to detect an object from an image, and predict a movement of the object. The object detection algorithm may adopt an artificial intelligence (AI)-based algorithm, and a pre-trained artificial neural network model is applied to detect the object. For example, a Kalman filter may be used to predict the movement of the object.

Meanwhile, the image management server 200 may store various AI-based learning models suitable for a purpose of image analysis. The learning model may include an object classification function. The object classification function may include a gender classification function such as whether a recognized object is a person, and when the recognized object is the person, whether the recognized object is a female or a male. Further, the learning model may include a function to distinguish whether an entire person is detected when the recognized object is the person. Further, the object classification function may determine whether the recognized object is an automobile. Further, when the recognized object is the automobile, the learning model may determine a type of automobile and a size of the automobile.

In addition, the image management server 200 may generate metadata and index information for the metadata by analyzing the received image. The image management server 200 may analyze image information and/or sound information included in the received image jointly or separately to generate the metadata and the index information for the metadata.

The image management server 200 may correspond to at least one processor, or may include at least one processor. For example, the image management server 200 may include a hardware device such as a microprocessor or a general-purpose computer system.

The surveillance camera system 10 may further include a storage device capable of performing wired/wireless communication with the surveillance camera 100 and/or the image management server 200. The storage device may transmit an information provision request signal for requesting provision of all or some of images to the surveillance camera 100 or the image management server 200 to receive data of all images or some images. The received data of all or some images may be stored in a provided storage medium, and may be transmitted to the image management server 200 at a request of the image management server 200. The storage device may transmit, to the image management server 200, an information provision request signal for requesting metadata and/or index information for the metadata obtained by analyzing an image and an information provision request signal for requesting whether an object is present, a classification result of the object, and the like according to an image analysis result, and receive and store the obtained metadata and/or index information for the metadata.

The surveillance camera system 10 may further include the communication network N which is a wired/wireless communication path between the surveillance camera 100 and the image management server 200. The communication network N disclosed in the present disclosure may be, for example, a wireless network, a wired network, a public network such as the Internet, a private network, a Global System for Mobile communication network (GSM) network, a General Packet Radio Network (GPRN), a Local Area Network (LAN), a Wide Area Network (WAN), a Metropolitan Area Network (MAN), a cellular network, a Public Switched Telephone Network (PSTN), a Personal Area Network, Bluetooth, Wi-Fi Direct, Near Field communication, Ultra-Wide band, a combination thereof, or any other network, but the scope of the present disclosure is not limited thereto.

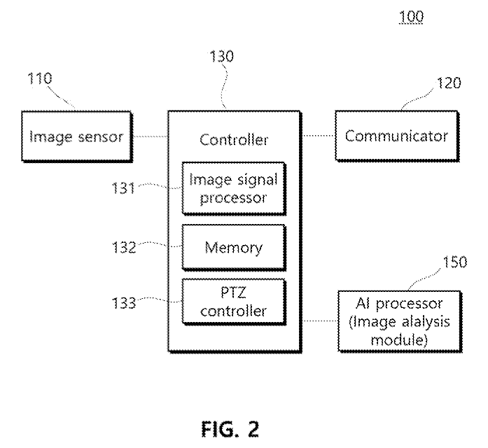

FIG. 2 is a block diagram schematically illustrating an internal configuration of the surveillance camera illustrated in FIG. 1.

Referring to FIG. 2, an example in which the surveillance camera 100 is a network camera that generates an image analysis signal by performing an intelligent image analysis function will be described, but an operation of the surveillance camera system according to the embodiment of the present disclosure is not particularly limited thereto.

The surveillance camera 100 may be configured to include an image sensor 110, a communicator 120, a controller 130, and an AI processor 150. At least one of the illustrated components may not be required in the surveillance camera 100, and additional components may be included in the surveillance camera 100. The components may be implemented in hardware or software, or may be implemented through a combination of hardware and software.

The image sensor 110 which performs a function of obtaining an image by photographing a surveillance area may be implemented as, for example, a charge-coupled device (CCD) sensor, a complementary metal-oxide-semiconductor (CMOS) sensor, or the like. The image sensor 110 may also be referred to as an image acquirer or an image acquisition device.

The communicator 120 transmits the image data, voice data, a still image, and/or metadata to the image management server 200. The communicator 120 according to an embodiment may transmits the image data, the voice data, the still image, and/or the metadata to the image management server 200 in real time. The communicator 120 may perform at least one communication function of a wired/wireless local area network (LAN), Wi-Fi, ZigBee, Bluetooth, and Near Field Communication. The communicator 120 may include any one or any combination of a digital modem, a radio frequency (RF) modem, an antenna circuit, a WiFi chip, and related software and/or firmware. The image management server 200 may include an image security solution such as digital video recorder (DVR), central management software (CMS), network video recorder (NVR), and video management software (VMS), and/or a display.

The controller 130 may control all overall operations and all other components related to the function of the surveillance camera 100 or process data input to and output from its components. The components of the controller 130 may include an image signal processor 131, a memory 132, and a PTZ controller 133.

The image signal processor 131 performs an operation of encoding an image obtained through the image sensor 110 into a digital signal, which may comply with, for example, H.264, H.265, Moving Picture Experts Group (MPEG), and Motion Joint Photographic Experts Group (M-JPEG) standards, and the like.

The image signal processor 131 may generate a surveillance image by processing an image signal which is input in real time. The surveillance image may be an image obtained by photographing a surveillance area of the surveillance camera 100, and may include predetermined thumbnail image information corresponding to the surveillance area and event capturing image information generated in the surveillance area.

The memory 132 may store a program for an operation of the controller 130, and may temporarily store input/output data.

In addition, the memory 132 may store image data, voice data, still image, metadata, and the like generated by the image signal processor 131. The metadata may be data including object detection information (movement, sound, intrusion into a designated area, or the like) photographed in the surveillance area, object identification information (person, car, face, hat, clothes, or the like), and detected location information (coordinates, size, and the like). In addition, the still image is generated jointly with the metadata and stored in the memory 132, and may be generated by capturing image information for a specific analysis area among the image analysis information. As an example, the still image may be implemented as a JPEG image file. As an example, the still image may be generated by cropping and a specific area of image data determined to be an identifiable object among image data of the surveillance area detected in a specific area and during a specific period, and may be transmitted jointly with the metadata in real time.

In addition, the memory 132 may serve to store and manage information unique to the surveillance camera (e.g., a camera identifier (ID)), camera position information, and the like.

The PTZ controller 133 may serve to change PTZ coordinates of a camera according to set preset information. As an example, the preset information may be set by an administrator through the image management server 200, and the administrator may control a position, a direction, a zoom degree, and the like of the surveillance camera 100 by changing the PTZ coordinate using the preset information of the surveillance camera 100. To this end, the surveillance camera 100 may include a driving device including one or more motors capable of controlling a pan, a tilt, and a zoom of the camera.

The controller 130 may be implemented as a processor configured to process instructions of a computer program by performing basic arithmetic, logic, and input/output operations. The instructions may be provided to the processor from the memory 132. As an example, the controller 130 may be configured to execute an instruction received according to a program code stored in a recording device such as the memory 132. Here, the controller 130 is implemented to execute an instruction according to a code of an operating system and at least one program code included in the memory 132. In this case, it may be understood that components in the controller 130, that is, the image signal processor 131 and the PTZ controller 133, separately represent different functions performed by the controller 130 according to a control instruction provided by the program code stored in the memory 132.

The AI processor 150 is for processing an image based on artificial intelligence, and applies an object detection and object tracking algorithm based on deep learning learned from an image obtained through the surveillance camera 10 according to an embodiment of the present disclosure. As illustrated in FIG. 2, the AI processor 150 may be implemented as a module independent of the controller 130 that controls the surveillance camera 100 throughout the system, or may be implemented as one module included in the controller 130. Further, the AI processor 150 may be implemented as a separate module or device of a form separated from the surveillance camera 100.

In the embodiment, a form of a camera module including the image sensor 110, the communicator 120, the controller 130, and the AI processor 150 may be provided.

The surveillance camera 100 may further include a housing that accommodates the image sensor 110, the communicator 120, the controller 130, and the AI processor 150 therein.

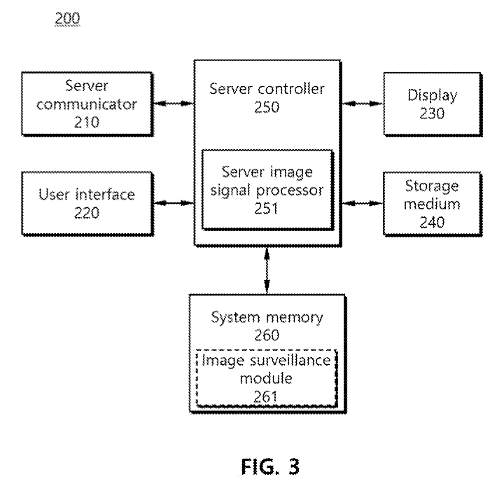

FIG. 3 is a block diagram schematically illustrating an internal configuration of an image management server illustrated in FIG. 1.

Referring to FIG. 3, the image management server 200 includes a server communicator 210, a user interface device 220, a display 230, a storage medium 240, a server controller 250, and a system memory 260.

The server communicator 210 may transmit and receive signals between the image management server 200 and the surveillance camera 100 (see FIG. 1) via a network.

The user interface device 220 receives a user input for controlling operations of the image management server 200 or the server controller 250. The user interface device 220 may include a keypad, a dome switch, a touch pad (resistive/capacitive), a jog wheel, a jog switch, a finger mouse, and the like.

The display 230 operates in response to control by the server controller 250. The display 230 displays information processed by the image management server 200 or the server controller 250. For example, the display 230 may display an image according to control by the server controller 250. The display 230 may receive and display a live view image captured by the surveillance camera 100 (in FIG. 1) or an image stored in the memory 132 (in FIG. 2). In addition, the display 230 may display various setting screens for controlling the surveillance camera 100. For example, the display 230 according to the embodiment may display a captured image, a privacy mask set in the image, and the like.

The storage medium 240 may be at least one of a flash memory, a hard disk, a solid state disk (SSD), a multimedia card memory, a random access memory (RAM), a static random access memory (SRAM), a read-only memory (ROM), an electrically erasable programmable read-only memory (EEPROM), a programmable read only memory (PROM), a magnetic memory, a magnetic disk, and an optical disk. The storage medium 240 is configured to write and read data in response to control by the server controller 250.

The server controller 250 may include any one of a general-purpose or a dedicated processor, and controls operations of the server communicator 210, the user interface device 220, the display 230, the storage medium 240, and the system memory 260.

The server controller 250 may include a server image signal processor 251. The server image signal processor 251 may decode image data encoded as a digital signal by the image signal processor 131 (in FIG. 2) and restore the image data to an image signal. This may comply with, for example, H.264, H.265, Moving Picture Experts Group (MPEG), and Motion Joint Photographic Experts Group (M-JPEG) standards, and the like.

The server image signal processor 251 may process the image data encoded as the digital signal by the image signal processor 131 (in FIG. 2) and process the processed image data to be output by the display 230.

The server controller 250 is configured to load program codes including instructions that, when executed, provide various functions from the storage medium 240 to the system memory 260, and execute the loaded program codes. The server controller 250 may load an image surveillance module 261 including instructions and/or program codes from the storage medium 240 to the system memory 260, and execute the loaded image surveillance module 261. The image surveillance module 261 may display an image and/or a video received from the surveillance camera 100 on the display 230, and detect a related user input. In addition, the image surveillance module 261 may visualize an additional user interface on the display 230, and detect a user input therethrough.

The system memory 260 may be provided as a working memory of the server controller 250. In the figure, the system memory 260 is illustrated as a component separate from the server controller 250, but this is illustrative and at least a portion of the system memory 260 may be integrated into the server controller 250. The system memory 260 may include at least one of a Random Access Memory (RAM), a Read Only Memory (ROM), and other types of computer-readable storage media.

The image management server 200 may further include an AI processor, and the AI processor may process an input image with a pre-learned artificial intelligence model alone or in collaboration with the server controller 250. Further, the AI processor may be driven in a form included in the server controller 250. The image surveillance module 261 may be an artificial intelligence model learned by the AI processor.

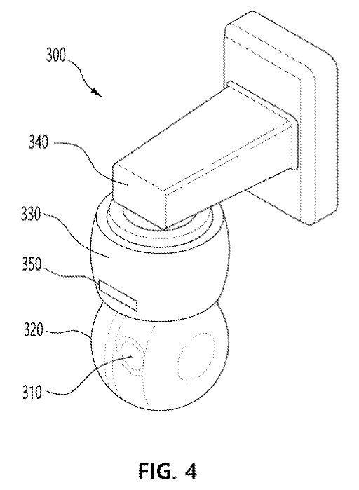

FIG. 4 illustrates the surveillance camera according to an embodiment of the present disclosure.

Referring to FIG. 4, a surveillance camera 300 according to an embodiment may include a camera module 310 which may include a lens, an image sensor, and the like, a dome 320 made of a transparent material and accommodating the camera module 310 therein, a housing 330, a camera fixing device 340, and a user terminal contact 350.

The camera module 310 may include all components of the surveillance camera 100 in FIG. 2. The surveillance camera 300 may drive a pan, a tilt, and a zoom, and the camera module 310 may drive the tilt and the zoom inside the dome 320.

The housing 330 accommodates the camera module 310 and various mechanical devices and electronic devices for driving the camera module 310 therein. For example, the housing 330 may accommodate not only the components of FIG. 2 but also a motor, an actuator, and the like for driving the pan, the tilt, and the zoom.

The housing 330 drives the pan jointly with the camera module 310 according to the driving of the pan of the camera module 310.

The housing 330 may be fixed to a wall surface, a ceiling, a pillar, or the like of an installation site through the camera fixing device 340. The camera fixing device 340 may be various types including a type for fixing the ceiling as well as a type for fixing the wall surface as illustrated in the figure.

The user terminal contact 350 may be formed on a portion of an outer peripheral surface of the housing 330. The user terminal contact 350 may be formed on a front surface or a side surface of the housing 330 with respect to the camera module 310.

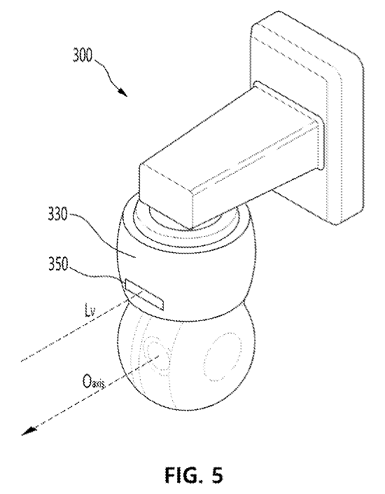

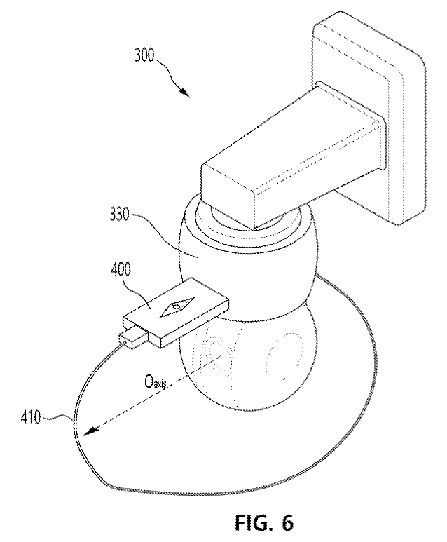

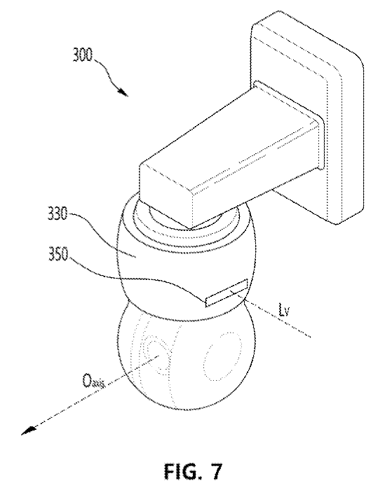

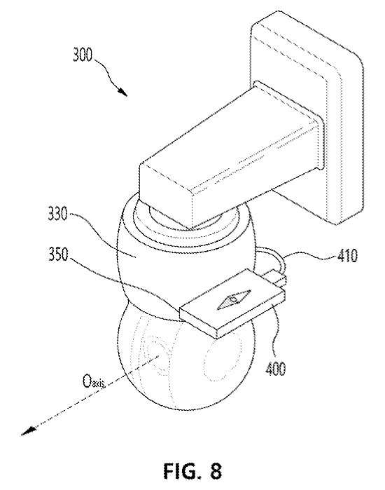

FIG. 5 illustrates an example in which a user terminal contact is formed on a front surface of a housing, FIG. 7 illustrates an example in which the user terminal contact is formed on a side surfaces of the housing, and FIGS. 6 and 8 illustrate use examples of the surveillance camera according to an embodiment of the present disclosure.

Referring to FIGS. 4 to 8, the user terminal contact 350 may be formed to include a flat plane so that a user terminal 400 may be accommodated while maintaining a predetermined angle with respect to a lens alignment direction or an optical axis of the camera module 310. The user terminal contact 350 may have a shape and an area determined such that at least a portion of a contact surface of the user terminal 400 is to be surface-contacted. The user terminal contact 350 may have an area larger than that of a contact surface of the user terminal 400 to be surface-contacted so that an entirety of the contact surface of the user terminal 400 may be surface-contacted. Further, in a state in which the contact surface of the user terminal 400 is surface-contacted with the user terminal contact 350, only a flat portion may be formed to maintain a position of the contact surface. In this case, a shape of the contact surface of the user terminal contact 350 may not be a rectangle illustrated in the figure, and the area may be smaller than an area of the contact surface of the user terminal 400.

FIG. 6 illustrates a use example in which position information and orientation information data of the user terminal 400 are transmitted to the surveillance camera 300 through a universal serial bus (USB) cable 410 after a contact surface of the user terminal 400 is surface-contacted with the user terminal contact 350 of the surveillance camera 300 formed on a front surface according to an embodiment. FIG. 8 illustrates a use example in which position information and orientation information data of the user terminal 400 are transmitted to the surveillance camera 300 through a USB cable 410 after a contact surface of the user terminal 400 is surface-contacted with the user terminal contact 350 of the surveillance camera 300 formed on a side surface according to an embodiment.

Referring to FIGS. 5 and 6, the contact surface of the user terminal contact 350 is formed to be perpendicular to the optical axis of the camera module 310.

For example, when the user terminal contact 350 is formed directly above the lens of the camera module 310, that is, on a front surface of the housing 330 as shown in a position represented by reference numeral 350 of FIG. 5, a vertical line Lᵥ to the user terminal contact 350 is formed to have a relationship parallel to an optical axis Oₐₓᵢₛ of the camera module 310.

Referring to FIGS. 7 and 8, the contact surface of the user terminal contact 350 is formed to be parallel to the optical axis of the camera module 310.

For example, when the user terminal contact 350 is formed on the side surface of the housing 330, that is, at a position represented by reference numeral 350 of FIG. 7, a vertical line Lᵥ to the user terminal contact 350 is formed to have a relationship perpendicular to the optical axis Oₐₓᵢₛ of the camera module 310.

In the embodiments of FIGS. 6 and 8, the user terminal 400 is a terminal capable of calculating position information by receiving a GPS signal and calculating orientation information by measuring a global magnetic field through a geo-magnetic sensor, and may be, for example, a smartphone or the like. The smartphone usually has a rectangular parallelepiped shape in which a thickness is thin and one direction is longer. Therefore, when one of the four side surfaces of the user terminal 400, which is a smartphone, comes into contact with the user terminal contact 350 to be surface-contacted, the optical axis of the camera module 310 and the contact surface of the user terminal 400 are positioned parallel or vertical to each other. When the surveillance camera 300 obtains the orientation information of the user terminal 400 in this state, the orientation information, that is, an orientation angle of the camera module 310 may be calculated using the obtained orientation information, and a reference direction (for example, a north direction) of the camera module 330 may be set based on the calculated orientation information.

In the embodiments of FIGS. 6 and 8, a case where the position information and the orientation information data of the user terminal 400 are transmitted to the surveillance camera 300 through the USB cable 410 has been described as an example, but may also be transmitted through wireless communication established between the user terminal 400 and the surveillance camera 300. As a wireless communication means, various methods such as Bluetooth, Wi-Fi Direct, near field communication (NFC), infrared communication, and Internet connection through a mobile phone communication network of the user terminal may be used, and are not limited only to wireless communication means listed here.

Meanwhile, the user terminal contact 350 or peripheries thereof may be provided with a phrase or a picture for guiding which surface of the four side surfaces of the user terminal 400 should be brought into contact with the user terminal contact 350 and the type of the contact surface. For example, the guide phrase or picture may guide the user terminal contact 350 to be contacted with an upper side surface of the user terminal 400, and guide the user terminal contact 350 to be contacted with one side surface in a longitudinal direction of the user terminal 400.

Referring back to FIG. 2 and referring further to FIGS. 4 to 8, the surveillance camera 100 may include the image sensor 110, the communicator 120 and the controller 130 with the memory 132 constituting the camera module 310. The memory 132 may be configured to be included in the controller 130, and may be configured as a separate device outside the controller 130.

Further, the surveillance camera 100 may include a housing 330 that accommodates the image sensor 110, the communicator 120, the controller 130 with the memory 132 therein.

The housing may include the user terminal contact 350 for accommodating the user terminal 400 at a predetermined angle with respect to the surveillance camera 100.

The communicator 120 may receive position information (hereinafter, referred to as user terminal position information) and orientation information (hereinafter, referred to as user terminal orientation information) of the user terminal 400 from the user terminal 400. The communicator 120 may receive the user terminal position information and the user terminal orientation information from the user terminal 400 through wired communication with the user terminal 400 via a USB cable or the like or wireless communication with the user terminal 400 such as Bluetooth, NFC, Wi-Fi Direct or the like.

The controller 130 may extract position information (hereinafter, referred to as surveillance camera position information) and orientation information (hereinafter, referred to as surveillance camera orientation information) of the surveillance camera 100 based on the user terminal position information and the user terminal orientation information received from the user terminal 400, and set the extracted surveillance camera position information and the extracted surveillance camera orientation information as the position information and the orientation information of the surveillance camera 100.

The memory 132 may store the camera position information and the camera orientation information. The stored camera position information and camera orientation information may be transmitted to the image management server 200 according to a user’s request.

The controller 130 may calculate the surveillance camera orientation information based on information of the contact surface of the user terminal 400 that is surface-contacted with the user terminal contact 350 and the user terminal orientation information. For example, as illustrated in FIG. 8, when a right side surface of the user terminal 400 is surface-contacted with the user terminal contact 350, the orientation angle of the user terminal 400 and the optical axis of the surveillance camera are parallel to each other, and thus the controller 130 may set the user terminal orientation information as the orientation information of the surveillance camera 100 as it is. As another example, when a front side surface of the user terminal 400 is surface-contacted with the user terminal contact 350, the orientation angle of the user terminal 300 and the optical axis of the surveillance camera are perpendicular to each other, and thus the controller 130 may set the orientation information of the surveillance camera by calculating the orientation information of the surveillance camera from the user terminal orientation information in consideration of such a perpendicular state.

The surveillance camera 100 may store an installation program for extracting the user terminal position information and the user terminal orientation information from the user terminal 400 and transmitting the extracted information to the surveillance camera 100. The installation program is provided by a manufacturer of the surveillance camera 100, and may be an application program for helping a user (a surveillance camera installer) to set a basic environment of the surveillance camera 100 after the user installs the surveillance camera 100 at an installation location of the surveillance camera 100. When the user terminal 400 is connected to the surveillance camera 100 by a wired communication means or a wireless communication means, the installation program may be automatically downloaded and installed on the user terminal 400. In addition, the installation program may be provided in the same type as a smartphone app, and the user may directly access an Electronic Software Distribution such as an app store, an app market, or a dedicated server of the user terminal 400, download the electronic software distribution, and install the downloaded on the user terminal 400.

The user may perform basic environment setting including input of orientation information and position information of the surveillance camera 100 installed according to guidance by the installation program installed in the user terminal 400. For example, when the user executes a menu for inputting the surveillance camera orientation information and the surveillance camera position information after executing the installation program, the installation program may output a user guidance image and/or voice to guide the user to correctly contact a contact surface of the user terminal 400 with the user terminal contact 350 outside the housing 330 so that the user terminal orientation information may be accurately measured. At this time, the user terminal 400 needs to be surface-contacted with the user terminal contact 350 while maintaining parallelism with respect to the ground so that a provided geomagnetic sensor may accurately measure the orientation angle. To this end, when it is determined that a posture of the user terminal 400 is kept horizontal with respect to the ground based on a measurement value of a gyro sensor or the like provided in the user terminal 400, the installation program may automatically transmit the measurement value of the geomagnetic sensor as the user terminal orientation information from the user terminal 400 to the communicator 120 of the surveillance camera 100. More specifically, when the user terminal 400 comes into contact with the user terminal contact 350 outside the housing 330, the installation program may determine, as the user terminal orientation information, the measurement value of the geomagnetic sensor at a moment when it is determined that the posture of the user terminal 400 maintains the horizontality with respect to the ground based on the measurement value of the gyro sensor provided in the user terminal 400, or may calculate the orientation angle of the user terminal 400 based on the measurement value of the geomagnetic sensor, component on spatial coordinates of an inclination vector, and the like, and then determine this as the user terminal orientation information when it is determined that the posture of the user terminal 400 is kept at an angle within a predetermined inclination with respect to a paper. When the posture of the user terminal 400 is not horizontal with respect to the ground, a method for calculating the orientation angle of the user terminal 400 by using a component on spatial coordinates of a slope vector adopts an existing known method, and thus a detailed description thereof is omitted herein. As another example, a time point at which the measurement value of the geomagnetic sensor is determined as the user terminal orientation information entirely follows the determination of the user, and when the user touches a setup button through the user interface of the installation program displayed on a display of the user terminal 400, the installation program may extract the user terminal position information and the user terminal orientation information from the user terminal 400 according to a user’s instruction, and then transmit the extracted user terminal position information and user terminal orientation information to the communicator 120 of the surveillance camera 100 through a communicator of the user terminal 400.

When a mobile phone communication network is used during wireless communication as a communication method between the communicator 120 of the surveillance camera 100 and the communicator of the user terminal 400, the installation program installed in the user terminal 400 may connect to the Internet through the mobile phone communication network, check an IP of the surveillance camera 100, and then transmit the user terminal position information and the user terminal orientation information to the surveillance camera 100 of the IP.

In addition, the user terminal 400 may transmit various sensing information that may be measured by the user terminal 400 and various data not mentioned in the present disclosure, including data required for setting the surveillance camera 100, as well as position information (latitude, longitude) and orientation information (orientation angle) of the user terminal, to the surveillance camera 100.

Meanwhile, the housing 330 may further include a magnetic field shielding film 351 and an electric field shielding film 352 for blocking a magnetic field generated by the surveillance camera 100 with respect to the user terminal contact 350. The housing 330 of the surveillance camera 100 may include, therein, devices that may generate an electric field and the magnetic field, such as a motor or an actuator for driving the pan, the tilt, and the zoom of the surveillance camera module. Since the electric field and the magnetic field interfere with the geomagnetic sensor of the user terminal and affect a magnetic field measurement value, the electric field and the magnetic field may adversely affect the user terminal 400 to calculate accurate orientation information. Therefore, in order to prevent the magnetic field and the electric field generated in the surveillance camera 100 from affecting the geomagnetic sensor in the user terminal 400, it is necessary to provide the magnetic field shielding film 351 and/or the electric field shielding film 352 in a predetermined area of an inner surface of the housing 330 in which the user terminal contact 350 is formed.

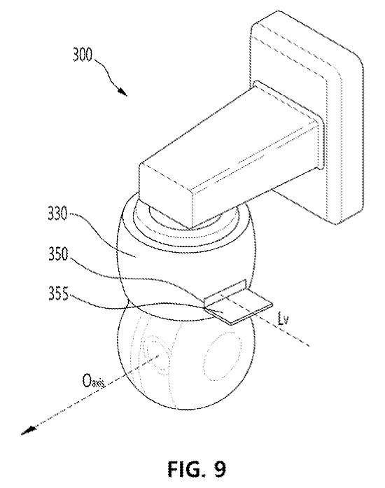

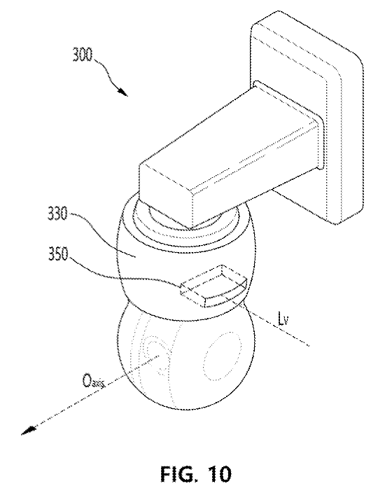

FIGS. 9 and 10 illustrate other examples of the user terminal contact formed in the housing.

Referring to FIG. 9, the user terminal contact 350 may be formed in a form of a flat surface on a part of the housing as in an illustrated example, and may be formed to further include a tray 355 that supports a surface-contacted user terminal in the air.

Referring to FIG. 10, the user terminal contact 350 may also be formed in a shape that may be recessed into the housing to accommodate the user terminal in an internal space thereof, as in the illustrated example. Even in this case, a contact surface with which one side surface of a user terminal is in contact in the user terminal contact 350 is formed such that a vertical line Lᵥ of the contact surface has a vertical relationship with an optical axis Oₐₓᵢₛ of a camera module.

The user terminal contact 350 may have any physical or mechanical configuration in which the pan is driven to the same extent together according to driving of the pan of the camera module as in the formed example of the housing 330.

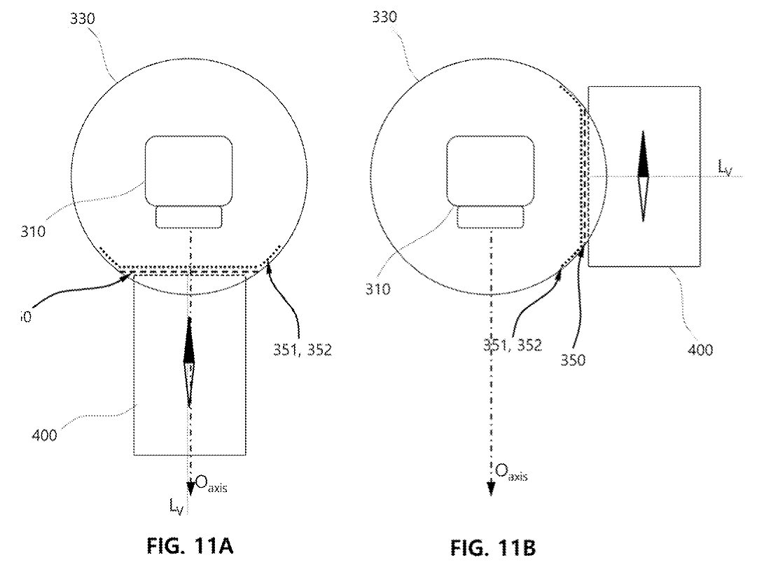

FIGS. 11A and 11B illustrate examples of use locations of a user terminal contact portion and a user terminal viewed down from an upper portion of the surveillance camera in the use examples of the surveillance camera according to an embodiment of the present disclosure of FIGS. 6 and 8, respectively.

Referring to FIG. 11A, a state in which a longitudinal front side surface of the user terminal 400 is disposed in contact with the user terminal contact 350 is illustrated. Therefore, an optical axis Oaxis of the camera module 310 is parallel to a vertical line Lv with respect to the user terminal contact 350.

Referring to FIG. 11B, a state in which one of longitudinal left and right side surfaces of the user terminal 400 is disposed in contact with the user terminal contact 350 is illustrated. Therefore, the optical axis Oaxis of the camera module 310 is perpendicular to the vertical line Lv for the user terminal contact 350.

The term “unit” (e.g., a controller, etc.) used herein may refer to, for example, a unit including one or a combination of two or more of hardware, software, or firmware. “Part” may be used interchangeably with terms, such as unit, logic, logical block, component, or circuit, for example. “Part” may be a minimum unit of an integral component or a portion thereof. “Part” may be a minimum unit performing one or more functions or a portion thereof. “Part” may be implemented mechanically or electronically. For example, “part” may include at least one of application-specific integrated circuit (ASIC) chip, field-programmable gate arrays (FPGAs), or programmable-logic devices, known or to be developed in the future, that perform predetermined operations.

At least a portion of a device (e.g., modules or functions thereof) or method (e.g., operations) according to various embodiments may be implemented with instructions stored in a computer-readable storage medium, e.g., in the form of a program module. When the instruction is executed by a processor, the one or more processors may perform the function corresponding to the instruction. Computer-readable medium includes all types of recording devices that store data that may be read by a computer system. Computer-readable storage mediums/computer-readable recording mediums may include hard disks, floppy disks, magnetic mediums (e.g. magnetic tape), optical mediums (e.g. compact disc read only memory (CD-ROM), digital versatile disc (DVD), magneto-optical mediums (e.g. floptical disk), hardware devices (e.g. read only memory (ROM), random access memory (RAM), or flash memory, etc.), and may also include those implemented in the form of a carrier wave (e.g., transmission via the Internet). Program instructions may include high-level language code that may be executed by a computer using an interpreter, etc., as well as machine language CODE, such as that generated by a compiler. The aforementioned hardware device may be configured to operate as one or more software modules to perform the operations of various embodiments and vice versa.

A module or program module according to various embodiments may include at least one of the aforementioned components, some of them may be omitted or may further include other additional components. Operations performed by modules, program modules, or other components according to various embodiments may be executed sequentially, in parallel, iteratively, or in a heuristic manner. In addition, some operations may be executed in a different order, omitted, or other operations may be added.

As used herein, the term “one” is defined as one or one or more. In addition, the use of introductory phrases, such as “at least one” and “one or more” in the claims should not be interpreted as meaning that, even if introductory phrases, such as “at least one” and “one or more” and ambiguous phrases, such as “one” is included in the same claim, the introduction, if any, of another claim element by the ambiguous phrase “one” does not mean that any particular claim including the introduced claimed element is limited to an invention including only one such element.

In this document, expressions, such as “A or B” or “at least one of A and/or B” may include all possible combinations of the items listed together.

Unless otherwise specified, terms, such as “first” and “second” are used to optionally distinguish between the elements described by such terms. Accordingly, these terms are not necessarily intended to indicate temporal or other priority of such elements, and the mere fact that particular means are recited in different claims does not indicate that a combination of such means cannot be advantageously used. Accordingly, these terms are not necessarily intended to indicate temporal or other priority of such elements. The mere fact that a particular measure is cited in different claims does not indicate that a combination of these measures cannot be used usefully.

Furthermore, terms such as “front,” “back,” “top,” “upper,” “lower part”, “bottom,” “over,” and “below” in the detailed description and claims are used for descriptive purposes and are not necessarily used to describe permanent relative positions. It is to be understood that such terms are interchangeable under appropriate circumstances, allowing the embodiments of the invention described herein to operate in orientations other than those illustrated or otherwise described herein.

For simplicity and clarity of illustration, it is to be understood that elements depicted in the drawings are not necessarily drawn to scale. For example, the dimensions of some elements may be exaggerated relative to other elements for clarity. Furthermore, where deemed appropriate, reference numerals may be repeated among the drawings to indicate corresponding or analogous elements.

The arrangement of components to achieve the same function is effectively “related” so that the desired function is achieved. Thus, any two components combined to achieve a particular functionality can be considered “related” to each other so that the desired function is achieved, regardless of the structure or intervening components. Likewise, two components so associated may be considered “operably connected” or “operably coupled” to each other to achieve the desired functionality. Furthermore, those skilled in the art will recognize that the boundaries between the functionality of the aforementioned operations are merely exemplary. Multiple operations may be combined into a single operation, a single operation may be distributed into additional operations, and operations may be executed with at least partial temporal overlap. Furthermore, alternative embodiments may include multiple instances of a particular operation, and the order of operations may vary in various other embodiments. However, other modifications, variations, and alternatives are also possible. Accordingly, the detailed description and drawings should be considered in an illustrative rather than a restrictive sense.

The phrase “may be X” indicates that condition X may be met. This phrase also indicates that condition X may not be met. For example, a reference to a system including a specific component should also include scenarios in which the system does not include a specific component. For example, a reference to a method that includes a specific operation should also include scenarios in which the method does not include a specific component. However, as another example, a reference to a system configured to perform a specific operation should also include scenarios in which the system is not configured to perform a specific task.

The terms “comprising,” “including,” “having,” “configured,” and “consisting essentially of” are used interchangeably. For example, any method may include at least the operations included in the drawings and/or the specification or may include only the operations included in the drawings and/or the specification. Alternatively, the word “comprising” does not exclude the presence of elements or acts listed in a claim.

Those of ordinary skill in the art may appreciate that the boundaries between logical blocks are merely exemplary. It will be appreciated that alternative examples may combine logical blocks or circuit elements with each other or may functionally divide various logical blocks or circuit elements. Therefore, an architecture shown herein is only exemplary. In fact, it should be understood that various architectures may be implemented that achieve the same function.

Further, for example, in one example, the illustrated examples may be implemented on a single integrated circuit or as a circuit disposed within the same device. Alternatively, the examples may be implemented as any number of individual integrated circuits or individual devices interconnected with each other in a suitable manner. Other changes, modifications, variations and alternatives may be present. Accordingly, the specification and drawings are to be regarded as illustrative and not restrictive.

Further, for example, the examples or some of thereof may be implemented using physical circuits such as any suitable type of hardware description language, or software or code representations of logical representations convertible to physical circuits.

Further, the present disclosure is not limited to a physical device or unit implemented as non-programmable hardware, but may be applied to a programmable device or unit capable of performing a desired device function by operating according to an appropriate program code, such as a main frame generally referred to as a ‘computer system’, a mini computer, server, workstation, personal computer, notepad, PDA, electronic game player, automobiles and other embedded systems, mobile phones and various other wireless devices, etc.

A system, device or device mentioned herein may include at least one hardware component. At least one of the components, elements, modules and units (collectively "components" in this paragraph) represented by a block or an equivalent indication in the drawings including FIGS. 1 and 2 described above may use a direct circuit structure, such as a memory, a processor, a logic circuit, a look-up table, etc. that may execute the respective functions through controls of one or more microprocessors or other control apparatuses. Alternatively or additionally, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), graphic processing unit (GPU), another type of microprocessor, or the like that performs the respective functions. Two or more of these components may be combined into one single component which performs all operations or functions of the combined two or more components. Also, at least part of functions of at least one of these components may be performed by another of these components.

Connection as described herein may be any type of connection suitable for transmitting a signal from or to each node, unit or device via an intermediate device, for example. Thus, unless implied or otherwise stated, the connection may be direct connection or indirect connection, for example. Connection may include single connection, multiple connection, one-way connection or two-way connection. However, different examples may have different implementations of the connection. For example, separate one-way connection may be used rather than two-way connection, and vice versa. Further, a plurality of connections may be replaced with a single connection in which a plurality of signals are transmitted sequentially or in a time multiplexing scheme. Likewise, a single connection in which a plurality of signals are transmitted may be divided into various connections in which subsets of the signals are transmitted. Thus, there are many options for transmitting the signal.

In the above, embodiments of the technology of this specification have been described with reference to the accompanying drawings. Here, the terms or words used in this specification and claims should not be construed as being limited to their usual or dictionary meanings, but should be construed as meanings and concepts consistent with the technical idea of the present disclosure. The scope of the present disclosure is not limited to the embodiments disclosed herein, and the present disclosure may be modified, changed, or improved in various forms within the scope described in the spirit and claims of the present disclosure.

WHAT IS CLAIMED IS:

1. A surveillance camera comprising:
a communicator configured to receive, from a user terminal configured to measure position information and orientation information of the user terminal, the position information and the orientation information of the user terminal;
a controller configured to set position information and orientation information of the surveillance camera based on the position information and orientation information of the user terminal; and
a housing which accommodates the communicator and the controller therein,
wherein the housing comprises a user terminal contact configured to allow the user terminal to contact the user terminal contact at a predetermined angle with respect to the surveillance camera.

2. The surveillance camera of claim 1, wherein the user terminal contact is configured to allow a surface of the user terminal to contact the user terminal contact so that an optical axis of the surveillance camera and the surface of the user terminal are perpendicular or parallel to each other.

3. The surveillance camera of claim 2, wherein the user terminal contact has a shape and an area to be contacted with at least a portion of the surface of the user terminal.

4. The surveillance camera of claim 2, wherein the controller is configured to obtain the orientation information of the surveillance camera, based on information about the surface of the user terminal, which is contacted with the user terminal contact, and the orientation information of the user terminal.

5. The surveillance camera of claim 1, wherein the housing further comprises a magnetic field shielding film configured to block a magnetic field formed by an internal configuration of the housing with respect to the user terminal contact.

6. The surveillance camera of claim 1, wherein the communicator is configured to receive the orientation information of the user terminal from the user terminal based on determining that the user terminal is in a state of being horizontal to a ground surface or within a predetermined inclination range with respect to the ground surface.

7. A surveillance camera comprising:
a camera module; and
a housing which accommodates the camera module,
wherein the housing comprises a user terminal contact configured to allow a surface of a user terminal having orientation information to contact the user terminal contact at a predetermined angle with respect to an optical axis of the camera module.

8. The surveillance camera of claim 7, wherein the user terminal contact is configured to allow a surface of the user terminal to contact the user terminal contact so that an optical axis of the camera module and the surface of the user terminal are perpendicular or parallel to each other.

9. The surveillance camera of claim 8, wherein the user terminal contact has a shape and an area to be contacted with at least a portion of the surface of the user terminal.

10. The surveillance camera of claim 7, further comprising:
a communicator configured to receive the orientation information of the user terminal from the user terminal; and
a controller configured to set orientation information of the surveillance camera based on the orientation information of the user terminal based on the user terminal contacting the user terminal contact,
wherein the communicator is configured to receive the orientation information of the user terminal based on the orientation information of the user terminal being transmitted according to determination of a gyro sensor based inclination of an installation app installed in the user terminal.

11. The surveillance camera of claim 10, wherein the controller is configured to obtain the orientation information of the surveillance camera, based on information about the surface of the user terminal, which is contacted with the user terminal contact, and the orientation information of the user terminal.

12. The surveillance camera of claim 7, wherein a magnetic field shielding film configured to block a magnetic field formed by an internal configuration of the housing with respect to the user terminal contact is formed on an inner surface of the housing.

13. A surveillance camera comprising:
a housing which accommodates a camera module, a communicator, and a controller therein,
wherein a user terminal contact configured to allow a user terminal to contact the user terminal contact at a predetermined angle is formed on an outer surface of the housing,
wherein the communicator configured to receive position information and orientation information of the user terminal from the user terminal, and
wherein the controller is configured to set position information and orientation information of the surveillance camera based on the position information and the orientation information of the user terminal based on the user terminal contacting the user terminal contact.

14. The surveillance camera of claim 13, wherein the communicator is configured to receive the position information and the orientation information of the user terminal from the user terminal based on the user terminal being in a horizontal state with respect to a ground surface or in a state of being within a predetermined inclination value in a state in which the user terminal contacts the user terminal contact.

15. The surveillance camera of claim 13, wherein the user terminal contact is formed to be contacted with a surface of the user terminal so that an optical axis of the camera module and a surface of the user terminal are perpendicular or parallel to each other.

16. The surveillance camera of claim 15, wherein the user terminal contact has a shape and an area to be contacted with at least a portion of the surface of the user terminal.

17. The surveillance camera of claim 13, wherein the controller is configured to obtain the orientation information of the surveillance camera, based on information about the surface of the user terminal, which is contacted with the user terminal contact, and the orientation information of the user terminal.

18. The surveillance camera of claim 13, wherein the housing further comprises a magnetic field shielding film configured to block a magnetic field formed by an internal configuration of the housing with respect to the user terminal contact.
